(19) United States
(12) Patent Application Publication
(10) Pub. No.: US 2026/0025251 A1
(43) Pub. Date: Jan. 22, 2026

(54) HARQ-ACK CODEBOOK MANAGEMENT METHOD, APPARATUS, AND COMPUTER READABLE STORAGE MEDIUM

(71) Applicant: ZTE CORPORATION, Shenzhen (CN)

(72) Inventors: Wei GOU, Shenzhen (CN); Xianghui HAN, Shenzhen (CN); Xing LIU, Shenzhen (CN); Jing SHI, Shenzhen (CN); Shuaihua KOU, Shenzhen (CN)

(73) Assignee: ZTE CORPORATION, Shenzhen (CN)

(21) Appl. No.: 19/341,274

(22) Filed: Sep. 26, 2025

Related U.S. Application Data
(63) Continuation of application No. PCT/CN2023/087127, filed on Apr. 7, 2023.

(51) Int. Cl. H04L 5/00; H04W 72/232

(52) U.S. Cl. CPC H04L 5/0055; H04W 72/232

(57) ABSTRACT

Wireless communication methods are disclosed. A wireless communication method includes determining, by user equipment (UE), HARQ-ACK information of an HARQ-ACK codebook of at least one corresponding PDSCH group according to at least one of: at least one piece of first-formatted piece DCI (downlink control information), a parameter, a first signaling, a configuration of the UE, or a preset rule; and sending the HARQ-ACK codebook to a base station (BS).

### TECHNICAL FIELD

This disclosure is generally related to wireless communication, and more particularly wireless communication regarding HARQ-ACK codebook improvement.

### BACKGROUND

Wireless communication technologies are pivotal components of the increasingly interconnecting global communication networks. Wireless communications rely on accurately allocated time and frequency resources for transmitting and receiving wireless signals. HARQ-ACK provides the feedback to base station for downlink data transmission, i.e., PDSCH Data. The traditional semi-static codebook (the type 1 HARQ-ACK codebook) has an expensive overhead to feedback the transmission, and reducing the overhead can provide a better performance of the wireless communication.

### SUMMARY

This summary is a brief description of certain aspects of this disclosure. It is not intended to limit the scope of this disclosure.

According to some embodiment of this disclosure, a wireless communication method is provided. The wireless communication method includes determining, by user equipment (UE), HARQ-ACK information of an HARQ-ACK codebook of at least one corresponding PDSCH group according to at least one of: at least one first-formatted piece of DCI (downlink control information), a parameter, a first signaling, a configuration of the UE, or a preset rule; and sending the HARQ-ACK codebook to a base station (BS).

According to some embodiment of this disclosure, another wireless communication method is provided. The wireless communication method includes configuring, by a BS, a UE with a setting of a HARQ-ACK codebook; and receiving, by the BS, HARQ-ACK information of the HARQ-ACK codebook of at least one corresponding PDSCH group determined according to at least one of: at least one piece of first-formatted DCI (downlink control information), a parameter, a first signaling, a configuration of the UE, or a preset rule.

According to some embodiment of this disclosure, another wireless communication method is provided. The wireless communication method includes receiving at least one piece of first DCI; receiving a UL grant after the first DCI, the UL grant scheduling at least two PUCCHs; receiving at least one piece of second DCI after receiving the UL grant; and transmitting a HARQ-ACK codebook corresponding to the at last one piece of second DCI.

Still another embodiment of this disclosure provides a wireless communication apparatus, including a memory storing one or more programs and a processor electrically coupled to the memory and configured to execute the one or more programs to perform any method or step or their combinations in this disclosure.

Still another embodiment of this disclosure provides non-transitory computer-readable storage medium, storing one or more programs, the one or more program being configured to, when performed by a processor, cause to perform any method or step or their combinations in this disclosure.

According to some embodiments of this disclosure, one or more wireless communication methods are further disclosed, the methods include combinations of certain methods, aspects, elements, and steps (either in a generic view or specific view) disclosed in the various embodiments of this disclosure.

The above and other aspects and their implementations are described in greater detail in the drawings, the descriptions, and the claims.

### BRIEF DESCRIPTION OF THE DRAWINGS

Various exemplary embodiments of the present disclosure are described in detail below with reference to the following drawings. The drawings are provided for purposes of illustration only and merely depict exemplary embodiments of the present disclosure to facilitate the understanding of the present disclosure. Therefore, the drawings should not be considered as limiting of the breadth, scope, or applicability of the present disclosure. It should be noted that for clarity and ease of illustration these drawings are not necessarily drawn to scale.

FIG. 1 shows an exemplary wireless communication system according to embodiments of this disclosure.

FIG. 2 illustrates HARQ-ACK report sequence and corresponding time slots and PDSCH.

FIG. 3 illustrates the grouping of PDSCH resources into the PDSCH group candidates.

FIG. 4 shows the timing for downlink and uplink transmission.

### DETAILED DESCRIPTION

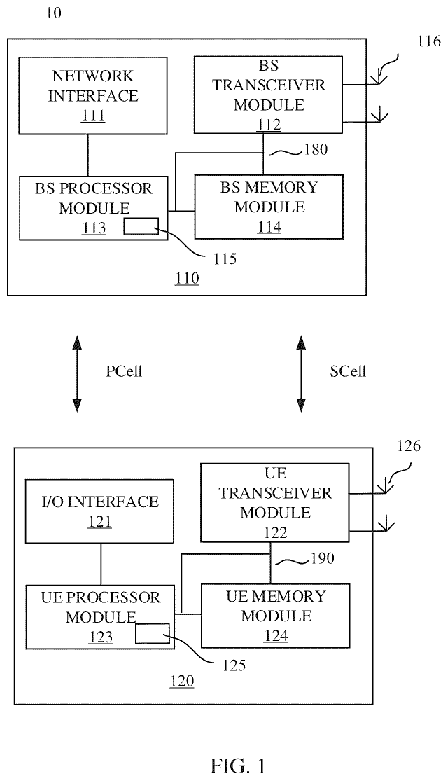

FIG. 1 illustrates a block diagram of an exemplary wireless communication system 10, in accordance with some embodiments of this disclosure. The system 10 may perform the methods/steps and their combination disclosed in this disclosure. The system 10 may include components and elements configured to support operating features that need not be described in detail herein.

The system 10 may include a base station (BS) 110 and user equipment (UE) 120. The BS 110 includes a BS transceiver or transceiver module 112, a BS antenna system 116, a BS memory or memory module 114, a BS processor or processor module 113, and a network interface 111. The components of BS 110 may be electrically coupled and in communication with one another as necessary via a data communication bus 180. Likewise, the UE 120 includes a UE transceiver or transceiver module 122, a UE antenna system 126, a UE memory or memory module 124, a UE processor or processor module 123, and an I/O interface 121. The components of the UE 120 may be electrically coupled and in communication with one another as necessary via a data communication bus 190. The BS 110 communicates with the UE 120 via communication channels therebetween, which can be any wireless channel or other medium known in the art suitable for transmission of data as described herein. The channels may include carriers of PCells and SCells.

The processor modules 113, 123 may be implemented, or realized, with a general-purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module performed by processor modules 113, 123, respectively, or in any practical combination thereof. The memory modules 113, 123 may be realized as RAM memory, flash memory, EEPROM memory, registers, ROM memory, EPROM memory, a hard disk, a removable disk, a CD-ROM, or any other form of storage medium known in the art. In this regard, the memory modules 114, 124 may be coupled to the processor modules 113, 123 respectively, such that the processors modules 113, 123 can read information from, and write information to, memory modules 114, 124 respectively. The memory modules 114, 124 may also be integrated into their respective processor modules 113, 123. In some embodiments, the memory modules 114, 124 may each include a cache memory for storing temporary variables or other intermediate information during execution of instructions to be performed by processor modules 113, 123, respectively. The memory modules 114, 124 may also each include non-volatile memory for storing instructions to be performed by the processor modules 113, 123, respectively.

### Semi-Static Codebook

A codebook is a sequence of bits, which is constructed using ACK/NACK feedback of multiple PDSCH reception for configured time window. Two type of HARQ Codebook is defined. Type 1 Codebook is fixed size Codebook provided by the gNB via RRC Signaling (Semi static). Type 2 Codebook having dynamic size and changes according to resource allocation (Dynamic). Total size of codebook is the total sum of transmission occasion of PDSCH for a given specific time window.

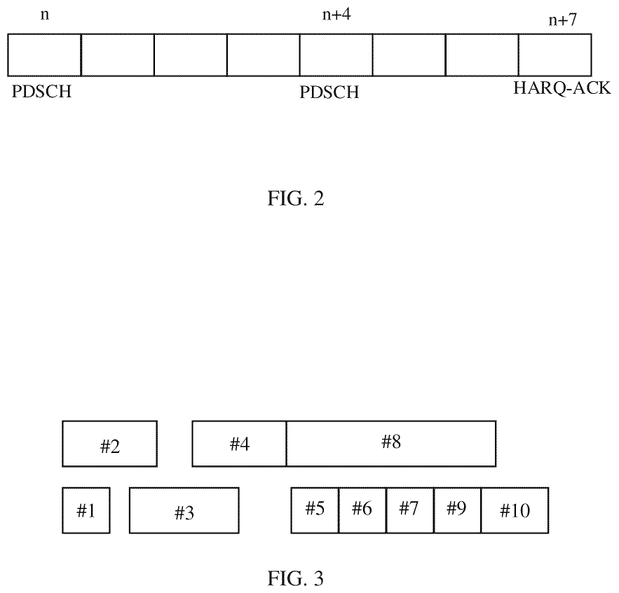

As an example in FIG. 2 where the UE is receiving a PDSCH in slot ‘n’ so the corresponding feedback will be sent in ‘n+k’ slot. ‘k’ can be determined by a ‘PDSCH-to-HARQ_feedback timing indicator’. As an example where DCI is used and k=7, HARQ-ACK codebook is being transmitted in the ‘n+7’ slot. As shown in FIG. 2, the PDSCH data are scheduled in n and n+4 time slots, and the HARQ-ACK can be concatenated together to form an HARQ-ACK codebook to be reported on time slot n+7. The HARQ-ACK codebook can include feedback of reception of PDSCHs, which are received in n, n+1, n+2, . . . n+6 slots.

### PDSCH Group Candidates and Assignment to Time Slot(s)

PDSCH groups are also known as the SLIV (Start and Length Indicator Value) groups. In a slot, PDSCH groups are divided from PDSCH candidate resources according to the predefined rules. For example, in a slot, a PDSCH candidate resource with the earliest end position and other PDSCH candidates that overlap the PDSCH candidate resource with the earliest end position in the time domain are divided into a PDSCH group (also known as PDSCH group candidate). Then repeating the above process for the remaining PDSCH candidate resources until all the PDSCH candidate resources are divided into corresponding PDSCH groups to form the PDSCH Group Candidates.

For example as shown in FIG. 3, there are PDSCH candidate resources #1 to #10. Following the rule above, PDSCH candidate resource #1 (the PDSCH candidate resource with the earliest end position) and PDSCH candidate resource #2 (an overlapping resource) are defined as the first group. Briefly speaking, there are seven PDSCH groups that can be defined from the arrangement in FIG. 3, which include group {#1, #2}, group {#3, #4}, group {#5, #8}, group {#6}, group {#7}, group {#9}, and group {#10}. A BS can assign a certain number of the PDSCH groups in a time slot from the selection of the 7 PDSCH group candidate, and it can also select a specific resource from the assigned group if the group include more than one PDSCH resource. For example, a BS can assign group {#1, #2} and group {#3, #4} in a time slot, and select PDSCH resource #2 and #3 for the respective group. As an example, each PDSCH group corresponds to 1 bit HARQ-ACK information. However, in the traditional semi-static codebook, the number of bits of the codebook is fixed and is according to the total number of the PDSCH group candidates the BS can assign; as an example, that is 7 here.

### DCI Indicator Indicating Assigned or Maximum Assigned PDSCH Groups

According to some embodiments in this disclosure, a parameter A is provided in at least one piece of DCI in at least one slot corresponding to a HARQ-ACK codebook. HARQ-ACK information in the HARQ-ACK codebook can be determined according to the parameter A. For example, the parameter A can be used to indicate the maximum number of PDSCH groups used in the at least one time slot corresponding to the HARQ-ACK codebook. The maximum number of PDSCH groups used in the at least one time slot corresponding to the HARQ-ACK codebook can be smaller than the number of the candidate PDSCH groups (like 7 above). For example, there can be two slots corresponds to a HARQ-ACK codebook, meaning that the HARQ-ACK of the PDSCHs in the two slots will be reported in the HARQ-ACK codebook. Assuming one PDSCH group is assigned to the first slot and three PDSCH resource groups are assigned to the second slot, as an example, the R can be 3 corresponding to the maximum number of the PDSCH groups in the first and second slots.

According to some example, a PDSCH group corresponds to one bit in the HARQ-ACK information. If there is no parameter indicated the PDSCH group(s), each time slot would need 7 bits of the HARQ-ACK information to accommodate possible 7 PDSCH group candidates; with the parameter A that indicates the number of PDSCH groups assigned or the maximum number of PDSCH groups assigned among the at least one time a slot of which the HARQ-ACK information is reported in a same HARQ-ACK codebook, the corresponding HARQ-ACK information only need to have the sufficient bits corresponding to the PDSCH group(s) that is actually assigned, which can be a subset of the all PDSCH group candidates. The overhead can therefore can be saved.

For example in some cases, the UE capability reported by the UE is to receive M (M>=2) PDSCHs that are time division multiplexed, and the UE is configured with a semi-static HARQ-ACK codebook. For a HARQ-ACK codebook, the BS may set the parameter A with the same value for all pieces of DCI corresponding to the HARQ-ACK codebook. Alternatively or additionally, the BS may set the value of the parameter A in the last DCI among the pieces of DCI corresponding to the same HARQ-ACK codebook. The UE receives the pieces of DCI and may determine, according to the parameter A, the used or assigned PDSCH groups in the time slots corresponding to the HARQ-ACK codebook. The UE can generate one HARQ-ACK information for each determined PDSCH groups. The generated HARQ-ACK information can be concatenated based on the order of the determined PDSCH groups in the parameter A to obtain the HARQ-ACK codebook. The number of determined PDSCH groups does not exceed M. Therefore, the BS may be, in some cases, required to schedule PDSCHs, where the number of PDSCHs scheduled for time division multiplexing does not exceed M.

For example, the parameter A can be a newly added parameter in DCI. The parameter A can use bitmap signaling. The bit number of the bitmap signaling can be equal to the number of PDSCH groups divided from the PDSCH candidate resources in the slot. For example, the definition of the parameter A may include one of the following: The parameter A describes (the number and location of) the PDSCH groups that may be used for PDSCH transmission in a slot; alternatively or additionally, the parameter A can describe (the number and location of) the PDSCH groups used to construct the HARQ-ACK codebook in the slot; alternatively or additionally, the parameter A may describe the maximum number of PDSCH groups used among time slot(s) corresponding to the same HARQ-ACK codebook; alternatively or additionally, the parameter A can describe the PDSCH groups used to generate HARQ-ACK information in the (each) slot corresponding to the HARQ-ACK codebook; alternatively or additionally, the parameter A may describe which PDSCH groups corresponding to PDSCH group candidates in the (each) slot corresponding to a HARQ-ACK codebook are used to generate HARQ-ACK information for the HARQ-ACK codebook.

According to some examples, if the HARQ-ACK codebook is transmitted in a PUSCH, the parameter A can also be added to the UL grant corresponding to the PUSCH. In extreme cases, if all pieces of DCI corresponding to the HARQ-ACK codebook are missed, the number of bits of the HARQ-ACK information of the HARQ-ACK codebook in the (each) slot can be determined based on the parameter A in the UL grant. That is, in the (each) slot corresponding to the HARQ-ACK codebook, a number of bits of the HARQ-ACK information of the HARQ-ACK codebook can be determined based on the parameter A in the UL grant. In this way, the final number of bits of the HARQ-ACK codebook can determined as the sum of the number of bits of the HARQ-ACK information in the each slot.

Based on these examples, the additional overhead can be saved for the HARQ-ACK codebook. For example, there are 7 PDSCH group candidates divided in a time slot (which is the PDSCH group candidates the BS can assign to the time slot), and M=4. The BS can schedule up to 4 TDM (time-divisional multiplexing) PDSCHs in a slot, and the UE can generate up to 4 bits of HARQ-ACK information, instead of 7 bits of HARQ-ACK information. For another example, the BS schedules two PDSCHs that are time division multiplexed. The BS can set the parameter A to indicate that the two PDSCH groups corresponding to the two PDSCHs are scheduled, so the UE only generates 2-bit HARQ-ACK information for the two PDSCH groups scheduled in the time slot based on the parameter A; the UE is not necessarily to generate 7-bit HARQ-ACK information for all PDSCH group candidates that may be assigned in the slot.

### Fallback in Certain Cases

According to some examples, DCI format 1-0 (noted as DCI 1-0) may be not easy to be added with parameter A, while DCI format 1-1 (DCI1-1) or DCI format 1-2 (DCI1-2) is more compatible with the additional parameter A. The following provides an alternative where the UE can determine using a fallback approach or use the parameter to generate the HARQ-ACK information.

According to some examples, the approach used to generate the HARQ-ACK information can be based on whether a certain format of DCI (such as first-formatted DCI) is received.

According to these examples, if at least one piece of first-formatted DCI (for example DCI1-0) is received, the number of bits of HARQ-ACK information corresponding to the HARQ-ACK codebook can be determined based on the number of PDSCH group candidates in the slot. That is when at least one piece of first-formatted DCI is received by the UE in the time slots corresponding to one HARQ-ACK codebook, the UE can use the fallback approach, instead of parameter A, to determine the number of bits of the HARQ-ACK information. The UE can use the total PDSCH group candidates available to generate the HARQ-ACK information, and according to the examples above, the HARQ-ACK information can be of 7 bits. In other words, if at least one piece of first-formatted DCI is transmitted by the BS for an HARQ-ACK codebook, the BS and the UE agree that the bit number of the HARQ-ACK information corresponding to the HARQ-ACK codebook can be determined based on the number of PDSCH group candidates in the slots.

According to these examples, if at least one piece of DCI containing the parameter A is still received, the bit number of HARQ-ACK information corresponding to the HARQ-ACK codebook in a slot can still be determined based on the parameter A. If at least one piece of DCI containing the parameter A is transmitted by the BS for the HARQ-ACK codebook, the BS and the UE agree that the bit number of the HARQ-ACK information corresponding to the HARQ-ACK codebook in a slot can be determined based on the PDSCH groups indicated by the parameter A, instead of the whole set of PDSCH group candidates. That is according to some examples, if at least one piece of DCI containing parameter A is sent by the BS for the HARQ-ACK codebook, the BS should include parameter A in each piece of DCI corresponding to the same HARQ-ACK codebook. If at least one piece of DCI containing parameter A is received by the UE for the HARQ-ACK codebook, the UE may consider that all pieces of DCI corresponding to the same HARQ-ACK codebook contain parameter A.

According to some other examples, the approach used to generate the HARQ-ACK information can be based on whether the UE is configured to receive at least one piece of first-formatted DCI (such as DCI1-0).

According to these examples, if UE is configured to receive at least one piece of first-formatted DCI, the number of bits of HARQ-ACK information corresponding to the HARQ-ACK codebook in a slot can be determined based on the number of PDSCH group candidates available in the slot (that is 7 according to the previous example). If the UE is configured to receive first-formatted DCI, the BS and the UE agree that the number of bits of the HARQ-ACK information corresponding to the HARQ-ACK codebook in a slot is determined based the number of PDSCH group candidates. The HARQ-ACK information can be of 7 bits for the time slot as there are seven candidate groups.

Additionally or alternatively, if UE is not configured to receive first-formatted DCI or the UE is configured to receive only DCI of other formats (such as DCI1-1 and/or DCI1-2), the number of bits of the HARQ-ACK information corresponding to the HARQ-ACK codebook in a slot can be determined based on the number of PDSCH group indicated by parameter A. If the UE is not configured to receive first-formatted DCI or the UE is configured to receive only DCI of other formats (such as DCI1-1 and/or DCI1-2), then the BS and the UE agree that the number of bits of the HARQ-ACK information for a time slot corresponding to the HARQ-ACK codebook can be determined based on the number of PDSCH groups indicated by the parameter A. If the UE is not configured to receive first-formatted DCI or the UE is configured to receive only DCI of other formats, then the BS should contain the parameter A in all pieces of DCI corresponding to the same HARQ-ACK codebook. If the UE is not configured to receive first-formatted DCI or is configured to receive only DCI of other formats, the UE considers that all pieces of DCI corresponding to the HARQ-ACK codebook contain parameter A.

### Carrier Aggregation

The approach to generate the HARQ-ACK information can also be based on the setting of carrier aggregation as the first-formatted DCI may be used under certain cases, but not the others.

According to some examples, if UE is configured for carrier aggregation and if the SCell of the UE is not configured as a self-scheduling cell (that is, the SCell is configured as a scheduled cell), then according to existing specifications, the PCell does not use first-formatted DCI to schedule the PDSCH of the SCell. The PDSCH in the SCell is not scheduled by first-formatted DCI. Therefore, in the SCell slot corresponding to the HARQ-ACK codebook, the bit number of HARQ-ACK information can be determined based on parameter A. The BS and the UE can agree that the bit number of the HARQ-ACK information for the SCell slot corresponding to the HARQ-ACK codebook can be determined based on the PDSCH groups indicated by the parameter A, instead of the whole set of PDSCH group candidates. The BS should include parameter A in each DCI corresponding to the same HARQ-ACK codebook. The UE may consider that all pieces of DCI corresponding to the same HARQ-ACK codebook contain parameter A.

Alternatively or additionally, if the UE is configured for carrier aggregation, and if the SCell of the UE is configured as a self-scheduling cell, and the first-formatted DCI is not configured to receive in the SCell (for example, configured to receive DCI of other formats (such as DCI1-1 and/or DCI1-2) in SCell only), then the PDSCH in the SCell is not scheduled by first-formatted DCI. Therefore, in the SCell slot corresponding to the HARQ-ACK codebook, the number of bits of the HARQ-ACK information can be determined based on the number of PDSCH group indicated by parameter A. The BS and the UE agree that the number of bits of the HARQ-ACK information for the SCell slot corresponding to the HARQ-ACK codebook can be determined based on the number of PDSCH groups indicated by the parameter A. The BS may contain the parameter A in all pieces of DCI corresponding to the same HARQ-ACK codebook. The UE may consider that all pieces of DCI corresponding to the HARQ-ACK codebook contain parameter A.

Alternatively or additionally, If UE is configured for carrier aggregation, and if the SCell of the UE is configured as a self-scheduling cell, and the first-formatted DCI is configured to receive in the SCell, the PDSCH in the SCell may be scheduled by first-formatted DCI. In this case, the number of bits of HARQ-ACK information for the SCell slot corresponding to the HARQ-ACK codebook can be determined based on the number of PDSCH group candidates in the SCell slot. That is when at least one piece of first-formatted DCI is received by the UE in the time slots corresponding to one HARQ-ACK codebook, the UE can use the fallback approach, instead of parameter A, to determine the number of bits of the HARQ-ACK information. The UE can use the total PDSCH group candidates available to generate the HARQ-ACK information, and according to the examples above, the HARQ-ACK information can be of 7 bits. In other words, if at least one piece of first-formatted DCI is transmitted by the BS for an HARQ-ACK codebook, the BS and the UE agree that the bit number of the HARQ-ACK information for the SCell slot corresponding to the HARQ-ACK codebook can be determined based on the number of PDSCH group candidates in the SCell slot. However, if at least one piece of DCI containing parameter A is still received, the bit number of HARQ-ACK information for the SCell slot corresponding to the HARQ-ACK codebook can still be determined based on parameter A in the SCell slot. If at least one piece of DCI containing parameter A is transmitted by the BS for the HARQ-ACK codebook, the BS and the UE agree that the bit number of the HARQ-ACK information for the SCell slot corresponding to the HARQ-ACK codebook can be determined based on the PDSCH groups indicated by the parameter A in the SCell slot, instead of the whole set of PDSCH group candidates. That is according to some examples, if at least one piece of DCI containing parameter A is sent by the BS for the HARQ-ACK codebook, the BS should include parameter A in each DCI corresponding to the same HARQ-ACK codebook. If at least one piece of DCI containing parameter A is received by the UE for the HARQ-ACK codebook, the UE may consider that all pieces of DCI corresponding to the same HARQ-ACK codebook contain parameter A.

Alternatively or additionally, if the UE is configured for carrier aggregation, and if the first-formatted DCI is configured to be received in the PCell, the PDSCH in the PCell may be scheduled by first-formatted DCI. In this case, the number of bits of HARQ-ACK information for the PCell slot corresponding to the HARQ-ACK codebook can be determined based on the number of PDSCH group candidates in the PCell slot. That is when at least one piece of first-formatted DCI is received by the UE in the time slots corresponding to one HARQ-ACK codebook, the UE can use the fallback approach, instead of parameter A, to determine the number of bits of the HARQ-ACK information. The UE can use the total PDSCH group candidates available to generate the HARQ-ACK information, and according to the examples above, the HARQ-ACK information can be of 7 bits. In other words, if at least one piece of first-formatted DCI is transmitted by the BS for an HARQ-ACK codebook, the BS and the UE agree that the bit number of the HARQ-ACK information for the PCell slot corresponding to the HARQ-ACK codebook can be determined based on the number of PDSCH group candidates in the PCell slot. However, if at least one piece of DCI containing parameter A is still received, the bit number of HARQ-ACK information for the PCell slot corresponding to the HARQ-ACK codebook can still be determined based on parameter A in the PCell slot. If at least one piece of DCI containing parameter A is transmitted by the BS for the HARQ-ACK codebook, the BS and the UE agree that the bit number of the HARQ-ACK information for the PCell slot corresponding to the HARQ-ACK codebook can be determined based on the PDSCH groups indicated by the parameter A, instead of the whole set of PDSCH group candidates. That is according to some examples, if at least one piece of DCI containing parameter A is sent by the BS for the HARQ-ACK codebook, the BS should include parameter A in each DCI corresponding to the same HARQ-ACK codebook. If at least one piece of DCI containing parameter A is received by the UE for the HARQ-ACK codebook, the UE may consider that all pieces of DCI corresponding to the same HARQ-ACK codebook contain parameter A.

### Using High Level Signaling to Serve the Function of Parameter A

According to some example, the function of parameter A can be performed by a high level signaling, like an RRC (Radio Resource Control) message or a MAC CE (MAC Control Element). The determining of the HARQ-ACK information can be applied mutatis mutandis according to what is described above and below.

According to some examples, one or more PDSCH groups corresponding to a semi-static HARQ-ACK codebook are configured for UE via RRC messages or MAC CEs. The configuration signaling can indicate the number R and location of the configured PDSCH groups, where R>=2. The UE's capability reported by the UE is to receive M (M>=2) PDSCHs that are time division multiplexed, and the UE is configured with the semi-static HARQ-ACK codebook.

The BS may configure one or more PDSCH groups for UE to generate HARQ-ACK information for a HARQ-ACK codebook from the divided PDSCH group in a slot via an RRC message or MAC CE (hereinafter signaling A).

The UE may receive the one or more pieces of DCI (with or without the parameter A) corresponding to the HARQ-ACK codebook, determine the PDSCH groups corresponding to the HARQ-ACK codebook based on signaling A, and generate 1-bit HARQ-ACK information for each determined PDSCH group. The generated HARQ-ACK information is concatenated based on the order of the determined PDSCH groups in signaling A to obtain the HARQ-ACK codebook. The number of determined PDSCH groups does not exceed R, that is, when the BS is required to schedule PDSCHs, the number of scheduled TDM PDSCHs does not exceed R.

Signaling A is a newly added parameter in RRC message or MAC CE. Signaling A can use bitmap signaling. The bit number of the bitmap signaling can be equal to the number of PDSCH groups divided from the PDSCH candidate resources in the slot. The definition of signaling A can be at least one of the following: Signaling A describes (the maximum number and location of) the PDSCH groups that may be used in slot for PDSCH transmission; additionally or alternatively, Signaling A describes (the number and location of) the PDSCH groups corresponding to HARQ-ACK codebooks in slot; additionally or alternatively, Signaling A describes the PDSCH groups used to generate HARQ-ACK information in the (each) slot corresponding to the HARQ-ACK codebook; additionally or alternatively, Signaling A describes which PDSCH groups corresponding to PDSCH group candidates in the (each) slot corresponding to a HARQ-ACK codebook are used to generate HARQ-ACK information for the HARQ-ACK codebook; additionally or alternatively, signaling A can indicate a subset of the PDSCH group candidates.

As explained above regarding parameter A, the use of singling A can save the overhead of the HARQ-ACK information. In a slot, if the number of PDSCH groups actually scheduled by the BS is less than R, the UE still generates R HARQ-ACK information in the slot. For example, if the number of PDSCH groups divided in a slot (i.e. the PDSCH group candidates available to the slot) is 7 and R=4, and the actual number of PDSCH groups scheduled by the BS is 2, the BS and UE agree that 4 bits (as R=4) HARQ-ACK information is generated for the HARQ-ACK information in the slot. In this case, the 4 bits contain the additional overhead of 2 bits; yet, it still saves 3 bits comparing to the use of the 7 bits HARQ-ACK information corresponding to all the PDSCH group candidates.

### Agreement Between Network Node on Selection of PDSCH Groups

According to some embodiments, the BS and UE determine the PDSCH groups corresponding to the semi-static HARQ-ACK codebook from the divided PDSCH groups according to predefined rules.

For example, the determined PDSCH groups can be always evenly distributed among the divided PDSCH groups in the slot. The PDSCH group corresponding to the HARQ-ACK codebook is determined according to the following rules.

The number of PDSCH group candidates divided in a slot may include Qᵢ (i=0, 1, 2, 3, . . . , Q−1) in a chronological order. The UE's capability is to receive W number of time division multiplexed PDSCHs. The interval M can be equal to rounding up the quotient of Q divided by W, that is M=┌Q/W┐, where ┌┐ means rounding up to the nearest constant. The BS and the UE agree that the first determined PDSCH group is Q₀ or another PDSCH group candidate between Q₀ to Q_{Q-1}. Alternatively, the base station indicates the first determined PDSCH group through signaling. The determined PDSCH groups corresponding to the HARQ-ACK codebook can be the W PDSCH groups obtained from the first determined PDSCH group based on the interval M from a repeated sequence from Q₀ to Q_{Q-1}. For example, the PDSCH groups can be repeated to determine the PDSCH groups corresponding to the HARQ-ACK codebook. The PDSCH groups are cycled in the following order: Q₀, Q₁, Q₂, Q₃, Q₄, Q₅, Q₆, Q₀, Q₁, Q₂, Q₃, Q₄, Q₅, Q₆, Q₀, Q₁, Q₂, Q₃, Q₄, Q₅, Q₆, . . .

For example, assuming Q=7 and W=4, and Q₀ is the starting PDSCH group for the HARQ-ACK codebook, then M is 2, and Q₀, Q₂, Q₄, and Q₆ are determined for the HARQ-ACK codebook.

For example, assuming Q=7 and W=2, and Q₀ is the starting PDSCH group for the HARQ-ACK codebook, then M is 4, and Q₀, and Q₄ are determined for the HARQ-ACK codebook.

For example, assuming Q=7 and W=6, and Q₀ is the starting PDSCH group for the HARQ-ACK codebook, then M is 2, and Q₀, Q₂, Q₄, Q₆, Q₁, and Q₃ are determined for the HARQ-ACK codebook. In this example, the PDSCH groups are cycled to determine 6 PDSCH groups for the HARQ-ACK codebook.

### HARQ-ACKs Report Timing and PUCCH Repetition

According to the related art, a HARQ-ACK of a PDSCH can be scheduled by DCI, and a PUSCH can be scheduled by a UL grant. If the HARQ-ACK wants to be reused in the PUSCH, the DCI need to be received by the UE before the UL grant received by the UE. The UL grant is also a kind of DCI used to schedule uplink data transmission, which is also transmitted in a PDCCH. In addition, in the related art, if HARQ-ACKs are multiplexed in a PUSCH transmission scheduled by a UL grant, the number of bits of the multiplexed HARQ-ACKs is determined based on the UL DAI (downlink assignment index) in the UL grant. The PUSCH with repetitions scheduled by UL grant may also needs to comply with the above rules, and the relevant descriptions in the current specification are as follows.

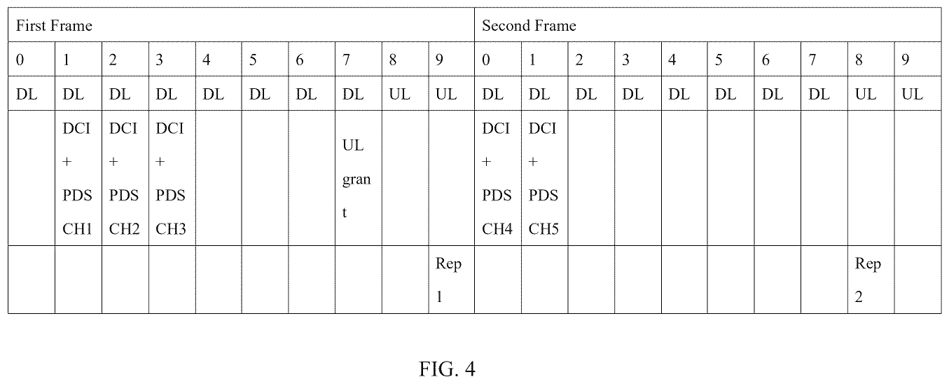

FIG. 4 shows a transmission timing sequence of between a BS and UE. The first row indicates the frames. The second row indicates the indices of the time slots, and the third row indicates the type of the slots (e.g., downlink (DL) or uplink (UL)). The fourth row indicates the content of DL transmission, and the bottom row indicates the UL transmission. DCI is transmitted in slot 1 of the first frame and used to schedule a PDSCHI in slot 1; DCI is transmitted in slot 2 and used to schedule a PDSCH2 in slot 2 of the first frame; DCI is transmitted in slot 3 and used to schedule a PDSCH3 in slot 3 of the first frame. The HARQ-ACKs of the PDSCH1, PDSCH2, and PDSCH3 are indicated for transmission in slot 9 of the first frame, so the slot 9 includes the upload transmission of the corresponding HARQ-ACKcodebook. DCI is transmitted in slot 0 of the second frame and used to schedule a PDSCH4 in slot 0 of the second frame, and DCI is transmitted in slot 1 of the second frame and used to schedule a PDSCH5 in slot 1 of the second frame. The HARQ-ACKs of both the PDSCH4 and PDSCH5 are indicated for transmission in slot 8 of the second frame. A UL grant is transmitted in slot 7 of the first frame and used to schedule a PUSCH with two repetitions. The first repetition (Rep1) is transmitted in slot 9 of the first frame, and the second repetition (Rep2) is transmitted in slot 8 of the second frame.

In this way, according to the above current specifications, the HARQ-ACKs of PDSCH1, PDSCH2, and PDSCH3 can be multiplexed in the first repetition (Rep1) of the PUSCH because the pieces of DCI of PDSCH1, PDSCH2, and PDSCH3 are received before the UL grant of the PUSCH. The HARQ-ACKs of PDSCH4 and PDSCH5 cannot be multiplex in the second repetition of the PUSCH because the pieces of DCI of PDSCH4 and PDSCH5 is not received before the UL grant of the PUSCH. Therefore, the HARQ-ACKs of PDSCH4 and PDSCH5 have to be delayed without further improvement, which will cause additional delay and is not conducive to improve system performance.

For the PUSCH transmission with repetitions scheduled by a UL grant and the HARQ-ACKs corresponding to the PDSCHs scheduled by the DCI (or the HARQ-ACKs corresponding to DCI), if the HARQ-ACKs want to be multiplexed in PUSCH repetitions (called remaining repetitions) other than the first repetition in FIG. 4, the BS and UE agree on the following rules.

### Allowing HARQ-ACK of PDSCH Schedule After UL Grant to Report

If HARQ-ACKs want to be multiplexed in a remaining repetition of the PUSCH transmission, the pieces of DCI corresponding to the HARQ-ACKs can be transmitted at a time (like slot 0 and slot 1 in FIG. 4) after the UL grant corresponding to the PUSCH transmission, but must be transmitted before the remaining repetition(s) (e.g., before Rep 2 in FIG. 4).

In addition, the number of the bits of HARQ-ACKs multiplexed in the remaining repetition (e.g., Rep 2 in FIG. 4) can be determined based on the UL DAI (downlink assignment index) in the UL grant. Alternatively or additionally, it may also be that a part of the pieces of DCI can be transmitted at a time before the UL grant, and the remaining pieces of DCI in the pieces of DCI is after the UL grant and before the remaining repetition. The number of bits of the HARQ-ACKs can be determined based on the UL DAI in the UL grant including.

According to some implementations, the number of bits of the HARQ-ACKs in the following repetition (e.g., Rep 2 in FIG. 4) can be equal to the number of bits of the HARQ-ACKs multiplexed in the first PUSCH repetition (e.g., Rep 1 in FIG. 4). For example, if the HARQ-ACKs multiplexed in the first PUSCH repetition are of 3 bits, then the HARQ-ACKs multiplexed in the remaining repetition(s) are also of 3 bits. With that said, more than 3 bits of HARQ-ACKs may not be able to be scheduled for the remaining repetition(s). If HARQ-ACKs less than 3 bits are scheduled for the remaining repetition, the BS and UE agree that the “0” can be added to the end of the HARQ-ACKs until the number of bits of the HARQ-ACKs reaches 3 bits. Referring back to FIG. 4, accordingly, since the HARQ-ACKs multiplexed in the first PUSCH repetition are 3 of bits, the HARQ-ACKs multiplexed in the second PUSCH repetition should have 3 bits; the last bit of the 3 bits is one added “0,” assuming PDSCH4 and PDSCH5 corresponding to Rep 2 each only consume one bit.

According to some other implementations, the number of bits of the HARQ-ACKs is determined based on the UL DAI and the number of received pieces of DCI corresponding to the HARQ-ACKs. Yet in this case, the number of bits of the HARQ-ACKs multiplexed in the remaining repetition(s) may not necessarily be equal to the number of bits of the HARQ-ACKs multiplexed in the first PUSCH repetition in some cases.

For example, a typical UL DAI corresponds to 2 bits, so a cycle count of 4 can be used. The value of the UL DAI is defined as {0, 1, 2, 3} corresponding to HARQ-ACKs of 1, 2, 3 and 4 bits, respectively. When UL DAI is 1, it can represent 2 bits HARQ-ACKs, or 6 (i.e., 2+4) bits HARQ-ACKs, or 10 (i.e., 2+4+4) bits HARQ-ACKs. In order to determine the actual value of UL DAI, the number of pieces of DCI received for scheduling PDSCH also needs to be considered. For example, if the value of the UL DAI is 1 and no more than 2 pieces of DCI corresponding to the HARQ-ACKs are received, the number of bits of the HARQ-ACKs is 2 bits. Alternatively, if the value of the UL DAI is 1 and more than 2 and no more than 6 pieces of DCI corresponding to the HARQ-ACKs are received, the number of bits of the HARQ-ACKs is 6 bits. Alternatively, if the value of the UL DAI is 1 and more than 6 and no more than 10 pieces of DCI corresponding to the HARQ-ACKs are received, the number of bits of the HARQ-ACKs is 10 bits. That is, the number of bits of the HARQ-ACKs in one repetition can be determine according to the DAI in the UL grant that scheduled the repetition and also according to the number of received pieces of DCI.

Therefore, in these implementations, if the UL DAI value in the UL grant corresponding to the scheduled PUSCH with repetitions is 1, and no more than 2 pieces of DCI corresponding to a HARQ-ACKs are received, and the HARQ-ACKs want to be transmitted in the first PUSCH repetition, the 2-bit HARQ-ACKs are multiplexed in the first PUSCH repetition. Alternatively, if the UL DAI value in the UL grant corresponding to the scheduled PUSCH with repetitions is 1, and more than 2 but not more than 6 pieces of DCI corresponding to a HARQ-ACKs are received, and the HARQ-ACKs want to be transmitted in the second PUSCH repetition, then the 6-bit HARQ-ACKs are multiplexed in the second PUSCH repetition.

### The Alternative or Supplemental Approaches

Similarly, the approaches can be explained as follows. UE does not expect the pieces of DCI corresponding to the HARQ-ACKs multiplexed in the remaining PUSCH repetition(s) other than the first PUSCH repetition must be transmitted before the UL grant used to schedule the PUSCH with repetitions. In the other words, the UE expects that the pieces of DCI corresponding to the HARQ-ACKs multiplexed in the first PUSCH repetition is before the UL grant, but the pieces of DCI corresponding to the HARQ-ACKs multiplexed in the remaining PUSCH repetition(s) other than the first PUSCH repetition can be before the remaining PUSCH repetitions. The pieces of DCI corresponding to the HARQ-ACKs multiplexed in the remaining PUSCH repetition(s), following the first PUSCH repetition, can transmitted in time slots before or after the UL grant, but must be before the remaining PUSCH repetition(s). The UL grant is used to schedule a PUSCH with repetitions.

In the other words, for a PUSCH transmission over multiple slots scheduled by UL grant and the HARQ-ACKs corresponding to the PDSCHs scheduled by DCI (or the HARQ-ACKs corresponding to DCI), if the HARQ-ACKs want to be multiplexed in the PUSCH transmission in any slots other than the first slot from multiple slots, the BS and UE agree on the following rules.

If the HARQ-ACKs want to be multiplexed in a remaining slot (other than the first slot) of the PUSCH transmission, the pieces of DCI corresponding to the HARQ-ACKs can be transmitted by the BS after the UL grant corresponding to the PUSCH transmission, but the pieces of DCI must be before the remaining slot. The number of bits of HARQ-ACKs multiplexed in the remaining slot can be determined based on the UL DAI in the UL grant. It may also be that a part of the pieces of DCI can be transmitted before the UL grant, and the remaining pieces of DCI corresponding to the same HARQ-ACK codebook is transmitted after the UL grant but before the remaining repetition(s).

If a HARQ-ACKs is to be multiplexed in the remaining repetition(s), the remaining repetition(s) and the PUCCH of the HARQ-ACKs may needs to satisfy the multiplexed timeline defined by other specifications when the PUSCH and the PUCCH of HARQ-ACK overlap in the time domain.

In some cases, a PUSCH repetition cab be also described on a slot base. For example, if a PUSCH transmission is scheduled over multiple slots, the PUSCH transmission can also be a PUSCH transmission with repetitions. Each PUSCH repetition can be transmitted in one of the multiple slots. Therefore, the first repetition corresponds to the first slot among the multiple slots; the second repetition corresponds to the second slot among the multiple slots; and the third repetition corresponds to the third slot in the multiple slots, and so on.

### Application to Multi-Slot PUSCH Transmission

If a PUSCH transmission block is scheduled for transmission in a PUSCH transmission that spans over multiple slots, the transmission block can be divided into multiple parts. Each part is transmitted in one slot of the multiple slots in the PUSCH transmission. For example, a transmission block can be scheduled by UL grant to be transmitted in a PUSCH transmission across two slots. In this case, after the transmission block is encoded, the encoded data can be divided into two parts. The first part can be transmitted in the PUSCH in the first slot of the two slots, and the second part can be transmitted in the PUSCH in the second slot of the two slots.

For example, for the aforementioned PUSCH transmission, the PUSCH transmission in the first slot of the multiple slots is processed as the first PUSCH repetition of a PUSCH transmission with repetitions, and the PUSCH transmission in the second slot of the multiple slots is processed as the second PUSCH repetition of a PUSCH transmission with repetitions, and so on. If HARQ-ACKs want to be multiplexed in the PUSCH in the multiple slots except for the first slot, it is equivalent to that the HARQ-ACKs want to be multiplexed in the remaining PUSCH repetition(s) except for the first PUSCH repetition as described above. Therefore, the same technique can be used.

According to some embodiment, a wireless communication method is disclosed. The method includes determining, by user equipment (UE), HARQ-ACK information of an HARQ-ACK codebook of at least one corresponding PDSCH group according to at least one of: at least one piece of first-formatted piece DCI (downlink control information), a parameter, a first signaling, a configuration of the UE, or a preset rule; and sending the HARQ-ACK codebook to a base station (BS).

According to some examples, the method further includes receiving, by the UE, at least one of: at least one piece of DCI, including a parameter indicative of a number, M, and/or location of PDSCH groups for time slots corresponding to the HARQ-ACK codebook;
the at least one piece of first-formatted DCI in the time slots; or the first signaling indicating a number, R, and/or location of the PDSCH groups for the time slots corresponding to the HARQ-ACK codebook.

According to some examples, determining the HARQ-ACK information of the HARQ-ACK codebook includes determining a bit number of the HARQ-ACK information of the HARQ-ACK codebook based on a number of PDSCH group candidates in the time slots when the at least one piece of first-formatted DCI present in the time slots corresponding to the HARQ-ACK codebook.

According to some examples, each of the at least one piece of DCI includes the parameter and determining the HARQ-ACK information of the HARQ-ACK codebook comprises determining a bit number of the HARQ-ACK information of the HARQ-ACK codebook based on the number M indicated by the parameter.

According to some examples, when the UE is configured to receive the at least one piece of first-formatted DCI, determining the HARQ-ACK information of the HARQ-ACK codebook includes determining a bit number of the HARQ-ACK information of the HARQ-ACK codebook based on a number of PDSCH group candidates a BS can assign in the time slots.

According to some examples, when the UE is configured to receive only DCI other than the first-formatted DCI, determining the HARQ-ACK information of the HARQ-ACK codebook includes determining a bit number of the HARQ-ACK information of the HARQ-ACK codebook based on the number M indicated by the parameter.

According to some examples, when the UE is in communication with a PCell and a SCell and the SCell is not self-scheduling, determining the HARQ-ACK information of the HARQ-ACK codebook includes determining a bit number of the HARQ-ACK information of the HARQ-ACK codebook for the SCell based on the number M indicated by the parameter.

According to some examples, wherein when the UE is in communication with a PCell and a SCell, the SCell is self-scheduling, and the SCell is not configured to receive the at least one piece of first-formatted DCI, determining the HARQ-ACK information of the HARQ-ACK codebook incldues determining a bit number of the HARQ-ACK information of the HARQ-ACK codebook for the SCell based on the number M indicated by the parameter.

According to some examples, when the UE is in communication with a PCell and a SCell and the SCell is configured to receive the at least one piece of first-formatted DCI, determining the HARQ-ACK information of the HARQ-ACK codebook includes determining a bit number of the HARQ-ACK information of the HARQ-ACK codebook for the SCell based on a number of PDSCH group candidates a BS can assign in the time slots.

According to some examples, when the UE is in communication with a PCell and a SCell and the PCell is configured to receive the at least one piece of first-formatted DCI, determining the HARQ-ACK information of the HARQ-ACK codebook comprises determining a bit number of the HARQ-ACK information of the HARQ-ACK codebook for the PCell based on a number of PDSCH group candidates a BS can assign in the time slots.

According to some examples, determining the HARQ-ACK information of the HARQ-ACK codebook of the at least one corresponding PDSCH group includes determining a bit number of the HARQ-ACK information of the HARQ-ACK codebook based on the number R indicated by the first signaling.

According to some examples, the first signaling includes an RRC signaling or a MAC CE.

According to some examples, determining HARQ-ACK information includes determining a bit number of the HARQ-ACK information equal to the number of the PDSCH groups indicated by the parameter or the first signaling or equal to a number of PDSCH group candidates a BS may assign in the time slots.

According to some examples, the number M of the parameter indicates a maximum number of PDSCH groups scheduled among the time slots corresponding to the HARQ-ACK codebook.

According to some examples, the number R of the first signaling is indicative either one of: a maximum number of PDSCH groups time slots corresponding to the HARQ-ACK codebook can be scheduled; or at least one PDSCH groups the time slots corresponding to the HARQ-ACK codebook is used.

According to some examples, determining HARQ-ACK information of the HARQ-ACK codebook according to the preset rule includes: determining the HARQ-ACK information of the HARQ-ACK codebook of at least one corresponding PDSCH group in a time slot, wherein the at least one PDSCH group in the time slot is determined according to a reported capacity for a number W of PDSCHs received for time division multiplexing in the time slot, and a number Q of PDSCH group candidates.

According to some examples, the at least one PDSCH group in the time slot is evenly selected from a repeated sequence of the PDSCH group candidates Qi, where i=0, 1, 2, 3, . . . , Q−1, within a M interval there between, where M=┌Q/W┐ and ┌.┐ is a round up function.

According to some embodiments of this disclosure, a wireless communication method is disclosed. The method includes: configuring, by a BS, a UE with a setting of a HARQ-ACK codebook; and receiving, by the BS, HARQ-ACK information of the HARQ-ACK codebook of at least one corresponding PDSCH group determined according to at least one of: at least one piece of first-formatted piece DCI (downlink control information), a parameter, a first signaling, a configuration of the UE, or a preset rule.

According to some examples, the method further includes sending, by the BS to the UE, at least one of: at least one piece of DCI, including a parameter indicative of a number, M, and/or location of PDSCH groups for time slots corresponding to the HARQ-ACK codebook; the at least one piece of first-formatted DCI in the time slots; or the first signaling indicating a number, R, and/or location of the PDSCH groups for the time slots corresponding to the HARQ-ACK codebook.

According to some examples, a bit number of the HARQ-ACK information of the HARQ-ACK codebook is determined based on a number of PDSCH group candidates in the time slots when the at least piece of first-formatted DCI present in the time slots corresponding to the HARQ-ACK codebook.

According to some examples, each of the at least one piece of DCI includes the parameter and a bit number of the HARQ-ACK information of the HARQ-ACK codebook is determined based on the number M indicated by the parameter.

According to some examples, when the UE is configured to receive the at least one piece of first-formatted DCI, a bit number of the HARQ-ACK information of the HARQ-ACK codebook is determined based on a number of PDSCH group candidates a BS can assign in the time slots.

According to some examples, when the UE is configured to receive only DCI other than the first-formatted DCI, a bit number of the HARQ-ACK information of the HARQ-ACK codebook is determined based on the number M indicated by the parameter.

According to some examples, when the UE is in communication with a PCell and a SCell and the SCell is not self-scheduling, a bit number of the HARQ-ACK information of the HARQ-ACK codebook for the SCell is determined based on the number M indicated by the parameter.

According to some examples, when the UE is in communication with a PCell and a SCell, the SCell is self-scheduling, and the SCell is not configured to receive the at least one piece of first-formatted DCI, a bit number of the HARQ-ACK information of the HARQ-ACK codebook for the SCell is determined based on the number M indicated by the parameter.

According to some examples, when the UE is in communication with a PCell and a SCell and the SCell is configured to receive the at least one piece of first-formatted DCI, a bit number of the HARQ-ACK information of the HARQ-ACK codebook for the SCell is determined based on a number of PDSCH group candidates a BS can assign in the time slots.

According to some examples, when the UE is in communication with a PCell and a SCell and the PCell is configured to receive the at least one piece of first-formatted DCI, a bit number of the HARQ-ACK information of the HARQ-ACK codebook for the PCell is determined based on a number of PDSCH group candidates a BS can assign in the time slots.

According to some examples, a bit number of the HARQ-ACK information of the HARQ-ACK codebook is determined based on the number R indicated by the first signaling.

According to some examples, the first signaling includes an RRC signaling or a MAC CE.

According to some examples, a bit number of the HARQ-ACK information is equal to the number of the PDSCH groups indicated by the parameter or the first signaling or equal to a number of PDSCH group candidates a BS may assign in the time slots.

According to some examples, the number M of the parameter indicates a maximum number of PDSCH groups scheduled among the time slots corresponding to the HARQ-ACK codebook.

According to some examples, the number R of the first signaling is indicative either one of: a maximum number of PDSCH groups time slots corresponding to the HARQ-ACK codebook can be scheduled; or at least one PDSCH groups the time slots corresponding to the HARQ-ACK codebook is used.

According to some examples, the HARQ-ACK information of the HARQ-ACK codebook corresponds to least one corresponding PDSCH group in a time slot, wherein the at least one PDSCH group in the time slot is determined according to a reported capacity for a number W of PDSCHs received for time division multiplexing in the time slot, and a number Q of PDSCH group candidates.

According to some examples, the at least one PDSCH group in the time slot is evenly selected from a repeated sequence of the PDSCH group candidates Qi, where i=0, 1, 2, 3, . . . , Q−1, within a M interval therebetween, where M=┌Q/W┐ and ┌.┐ is a round up function.

According to some examples, the HARQ-ACK codebook is a semi-statistic code book.

According to some embodiments of this disclosure, a wireless communication method is disclosed. The method includes: receiving at least one piece of first DCI; receiving a UL grant after the first DCI, the UL grant scheduling at least two PUCCHs; receiving at least one piece of second DCI after receiving the UL grant; and transmitting a HARQ-ACK codebook corresponding to the at last one piece of second DCI.

Various exemplary embodiments of the present disclosure are described herein with reference to the accompanying figures to enable a person of ordinary skill in the art to make and use the present disclosure. The present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art would understand that the methods and techniques disclosed herein present various steps or acts in exemplary order(s), and the present disclosure is not limited to the specific order or hierarchy presented unless expressly stated otherwise.

This disclosure is intended to cover any conceivable variations, uses, combination, or adaptive changes of this disclosure following the general principles of this disclosure, and includes well-known knowledge and conventional technical means in the art and undisclosed in this application.

It is to be understood that this disclosure is not limited to the precise structures or operation described above and shown in the accompanying drawings, and various modifications and changes may be made without departing from the scope of this application. The scope of this application is subject only to the appended claims.

The methods, devices, processing, circuitry, and logic described above may be implemented in many different ways and in many different combinations of hardware and software. For example, all or parts of the implementations may be circuitry that includes an instruction processor or controller, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when performed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when performed by the circuitry.

In some examples, each unit, subunit, and/or module of the system may include a logical component. Each logical component may be hardware or a combination of hardware and software. For example, each logical component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each logical component may include memory hardware, such as a portion of the memory, for example, that includes instructions executable with the processor or other processors to implement one or more of the features of the logical components. When any one of the logical components includes the portion of the memory that includes instructions executable with the processor, the logical component may or may not include the processor. In some examples, each logical component may just be the portion of the memory or other physical memory that includes instructions executable with the processor or other processor to implement the features of the corresponding logical component without the logical component including any other hardware. Because each logical component includes at least some hardware even when the included hardware includes software, each logical component may be interchangeably referred to as a hardware logical component.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

1. A wireless communication method, comprising:
determining, by user equipment (UE), HARQ-ACK information of an HARQ-ACK codebook of at least one corresponding PDSCH group according to at least one of: at least one piece of first-formatted piece DCI (downlink control information), a parameter, a first signaling, a configuration of the UE, or a preset rule; and
sending the HARQ-ACK codebook to a base station (BS).

2. The method of claim 1, further comprising receiving, by the UE, at least one of:
at least one piece of DCI, including a parameter indicative of a number, M, and/or location of PDSCH groups for time slots corresponding to the HARQ-ACK codebook;
the at least one piece of first-formatted DCI in the time slots; or
the first signaling indicating a number, R, and/or location of the PDSCH groups for the time slots corresponding to the HARQ-ACK codebook.

3. The method of claim 2, wherein determining the HARQ-ACK information of the HARQ-ACK codebook comprises determining a bit number of the HARQ-ACK information of the HARQ-ACK codebook based on a number of PDSCH group candidates in the time slots when the at least one piece of first-formatted DCI present in the time slots corresponding to the HARQ-ACK codebook.

4. The method of claim 2, wherein each of the at least one piece of DCI includes the parameter and determining the HARQ-ACK information of the HARQ-ACK codebook comprises determining a bit number of the HARQ-ACK information of the HARQ-ACK codebook based on the number M indicated by the parameter.

5. The method of claim 1, wherein when the UE is configured to receive the at least one piece of first-formatted DCI, determining the HARQ-ACK information of the HARQ-ACK codebook comprises determining a bit number of the HARQ-ACK information of the HARQ-ACK codebook based on a number of PDSCH group candidates a BS can assign in the time slots.

6. The method of claim 2, wherein when the UE is configured to receive only DCI other than the first-formatted DCI, determining the HARQ-ACK information of the HARQ-ACK codebook comprises determining a bit number of the HARQ-ACK information of the HARQ-ACK codebook based on the number M indicated by the parameter.

7. The method of claim 2, wherein when the UE is in communication with a PCell and a SCell and the SCell is not self-scheduling, determining the HARQ-ACK information of the HARQ-ACK codebook comprises determining a bit number of the HARQ-ACK information of the HARQ-ACK codebook for the SCell based on the number M indicated by the parameter.

8. The method of claim 1, wherein when the UE is in communication with a PCell and a SCell, the SCell is self-scheduling, and the SCell is not configured to receive the at least one piece of first-formatted DCI, determining the HARQ-ACK information of the HARQ-ACK codebook comprises determining a bit number of the HARQ-ACK information of the HARQ-ACK codebook for the SCell based on the number M indicated by the parameter.

9. The method of claim 1, wherein when the UE is in communication with a PCell and a SCell and the SCell is configured to receive the at least one piece of first-formatted DCI, determining the HARQ-ACK information of the HARQ-ACK codebook comprises determining a bit number of the HARQ-ACK information of the HARQ-ACK codebook for the SCell based on a number of PDSCH group candidates a BS can assign in the time slots.

10. The method of claim 1, wherein when the UE is in communication with a PCell and a SCell and the PCell is configured to receive the at least one piece of first-formatted DCI, determining the HARQ-ACK information of the HARQ-ACK codebook comprises determining a bit number of the HARQ-ACK information of the HARQ-ACK codebook for the PCell based on a number of PDSCH group candidates a BS can assign in the time slots.

11. The method of claim 1, wherein determining the HARQ-ACK information of the HARQ-ACK codebook of the at least one corresponding PDSCH group comprisesdetermining a bit number of the HARQ-ACK information of the HARQ-ACK codebook based on the number R indicated by the first signaling.

12. (canceled)

13. The method of claim 2, wherein determining HARQ-ACK information comprises determining a bit number of the HARQ-ACK information equal to the number of the PDSCH groups indicated by the parameter or the first signaling or equal to a number of PDSCH group candidates a BS may assign in the time slots.

14. (canceled)

15. (canceled)

16. The method of claim 1, wherein determining HARQ-ACK information of the HARQ-ACK codebook according to the preset rule comprises: determining the HARQ-ACK information of the HARQ-ACK codebook of at least one corresponding PDSCH group in a time slot, wherein the at least one PDSCH group in the time slot is determined according to a reported capacity for a number W of PDSCHs received for time division multiplexing in the time slot, and a number Q of PDSCH group candidates.

17. The method of claim 16, wherein the at least one PDSCH group in the time slot is evenly selected from a repeated sequence of the PDSCH group candidates Qᵢ, where i=0, 1, 2, 3, . . . , Q−1, within a M interval there between, where
$$M = ⌈ \frac{Q}{W} ⌉$$
and ┐┐ is a round up function.

18. A wireless communication method, comprising:
configuring, by a BS, a UE with a setting of a HARQ-ACK codebook; and
receiving, by the BS, HARQ-ACK information of the HARQ-ACK codebook of at least one corresponding PDSCH group determined according to at least one of: at least one piece of first-formatted piece DCI (downlink control information), a parameter, a first signaling, a configuration of the UE, or a preset rule.

19. The method of claim 18, further comprising sending, by the BS to the UE, at least one of:
at least one piece of DCI, including a parameter indicative of a number, M, and/or location of PDSCH groups for time slots corresponding to the HARQ-ACK codebook;
the at least one piece of first-formatted DCI in the time slots; or
the first signaling indicating a number, R, and/or location of the PDSCH groups for the time slots corresponding to the HARQ-ACK codebook.

20. (canceled)

21. (canceled)

22. The method of claim 18, wherein when the UE is configured to receive the at least one piece of first-formatted DCI, a bit number of the HARQ-ACK information of the HARQ-ACK codebook is determined based on a number of PDSCH group candidates a BS can assign in the time slots.

23-26. (canceled)

27. The method of claim 1, wherein when the UE is in communication with a PCell and a SCell and the PCell is configured to receive the at least one piece of first-formatted DCI, a bit number of the HARQ-ACK information of the HARQ-ACK codebook for the PCell is determined based on a number of PDSCH group candidates a BS can assign in the time slots.

28. The method of claim 1, wherein a bit number of the HARQ-ACK information of the HARQ-ACK codebook is determined based on the number R indicated by the first signaling.

29-35. (canceled)

36. A wireless communication method comprising:
receiving at least one piece of first DCI;
receiving a UL grant after the first DCI, the UL grant scheduling at least two PUCCHs;
receiving at least one piece of second DCI after receiving the UL grant; and
transmitting a HARQ-ACK codebook corresponding to the at last one piece of second DCI.

37. (canceled)

38. (canceled)
